(19) United States
(12) Patent Application Publication
(10) Pub. No.: US 2026/0230956 A1
(43) Pub. Date: Aug. 6, 2026

(54) METHOD AND APPARATUS FOR OPTIMIZATION OF RESOURCE UTILIZATION IN MOBILITY

(71) Applicant: LG ELECTRONICS INC., Seoul (KR)

(72) Inventors: Siyoung CHOI, Seoul (KR); Daewook BYUN, Seoul (KR); Sunghoon JUNG, Seoul (KR); Sangwon KIM, Seoul (KR); Hongsuk KIM, Seoul (KR)

(73) Assignee: LG ELECTRONICS INC., Seoul (KR)

(21) Appl. No.: 19/154,470

(22) PCT Filed: Jan. 25, 2024
(86) PCT No.: PCT/KR2024/001191

§ 371 Date: Aug. 7, 2025

Related U.S. Application Data
(60) Provisional application No. 63/444,197, filed on Feb. 8, 2023.

(51) Int. Cl. H04W 36/00; H04W 36/08

(52) U.S. Cl. CPC H04W 36/0072; H04W 36/0058; H04W 36/08

(57) ABSTRACT

The present disclosure relates to optimization of resource utilization in mobility in wireless communications. According to an embodiment of the present disclosure, a method performed by a user equipment (UE) configured to operate in a wireless communication system comprises: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

### CROSS-REFERENCE TO RELATED APPLICATIONS

This application is the National Stage filing under 35 U.S.C. 371 of International Application No. PCT/KR2024/001191, filed on Jan. 25, 2024, which claims the benefit of U.S. Provisional Application No. 63/444,197 filed on Feb. 8, 2023, the contents of which are all hereby incorporated by reference herein in their entireties.

### TECHNICAL FIELD

The present disclosure is related to optimization of resource utilization in mobility in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform a mobility from a source cell to a target cell with better quality than the source cell. In the mobility procedure, network may have to reserve resources for a plurality of UEs. However, this resource reservation may lead to inefficient utilization of resources and thus resource shortage may occur in some cases.

### SUMMARY

An aspect of the present disclosure is to provide method and apparatus for optimization of resource utilization in mobility in a wireless communication system.

According to an embodiment of the present disclosure, a method performed by a user equipment (UE) configured to operate in a wireless communication system comprises: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a configuration for a candidate cell for a cell switch, wherein the configuration for the candidate cell comprises a plurality of resource configurations for the candidate cell; and transmitting, to the UE, a cell switch command for the candidate cell, wherein the cell switch command informs a resource configuration among the plurality of resource configurations for the candidate cell, wherein the cell switch is performed to the candidate cell based on the resource configuration informed by the cell switch command in the configuration for the candidate cell.

According to an embodiment of the present disclosure, a method performed by a network node configured to operate in a wireless communication system comprises: transmitting, to a user equipment (UE), a configuration for a candidate cell for a cell switch, wherein the configuration for the candidate cell comprises a plurality of resource configurations for the candidate cell; and transmitting, to the UE, a cell switch command for the candidate cell, wherein the cell switch command informs a resource configuration among the plurality of resource configurations for the candidate cell, wherein the cell switch is performed to the candidate cell based on the resource configuration informed by the cell switch command in the configuration for the candidate cell.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

According to an embodiment of the present disclosure, a non-transitory computer readable medium (CRM) has stored thereon a program code implementing instructions that, based on being executed by at least one processor, perform operations comprising: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

The present disclosure may have various advantageous effects.

For example, according to the present disclosure, network (NW) may preconfigure UE with one or more physical channel configurations for a bandwidth part (BWP) of a candidate cell. When the NW decides the UE to perform LTM execution to the candidate cell, the candidate cell may reserve one out of preconfigured physical channel configurations in the first BWP for the UE. Then, the NW may transmit an LTM command to the UE, indicating the physical channel configuration that the candidate cell is reserving for LTM execution. Upon receiving the LTM command from the NW, the UE may execute the LTM to the candidate cell—that is, the UE may apply the preconfiguration with the indications by the LTM command.

To this end, the network may prevent the resource shortage problem by dynamically allocating the physical resource for use by the UE at the moment of LTM execution. As a result, the efficiency of network resource utilization can be improved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a legacy handover procedure to which technical features of the present disclosure can be applied.

FIG. 9 shows an example of a conditional handover procedure to which technical features of the present disclosure can be applied.

FIG. 10 shows an example of a signaling procedure for LTM according to an embodiment of the present disclosure.

FIG. 11 shows an example of a method performed by a UE according to an embodiment of the present disclosure.

FIG. 12 shows an example of a signal flow between a UE and a network node according to an embodiment of the present disclosure.

FIG. 13 shows an example of a method for indicating a physical channel configuration in LTM according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

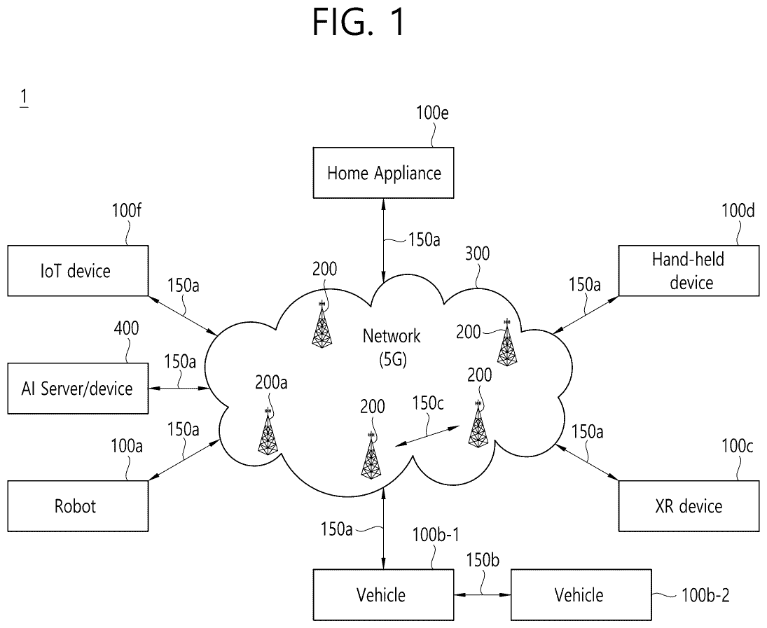

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier | |
|---|---|---|---|
| designation | frequency range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

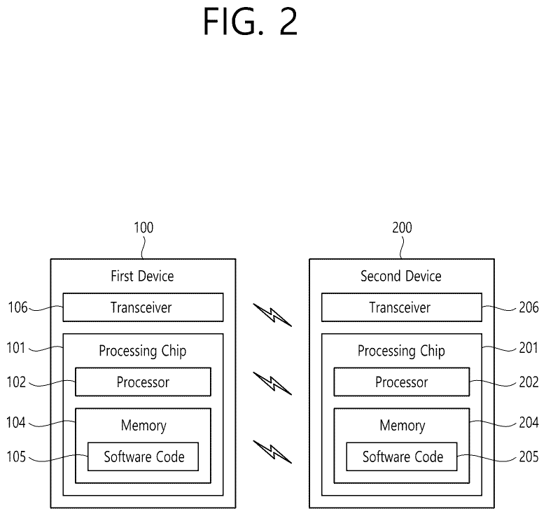

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

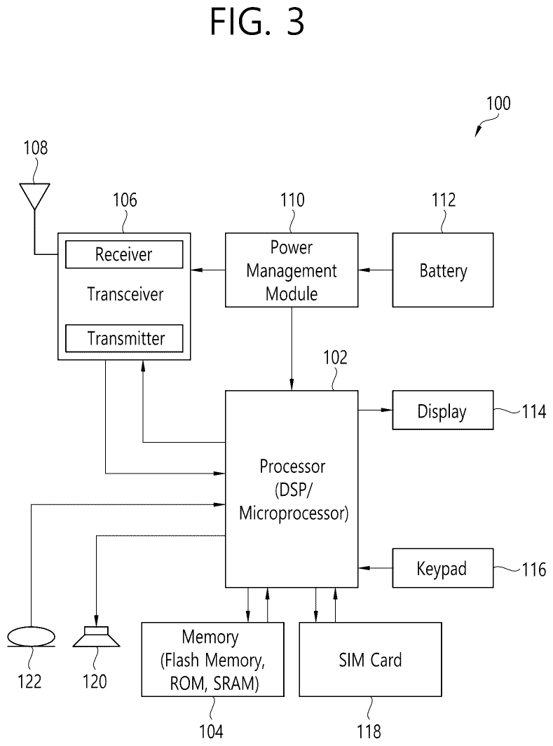

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

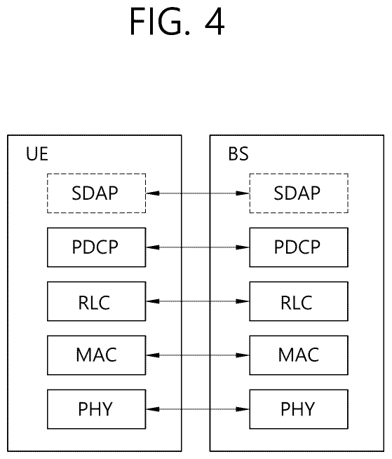

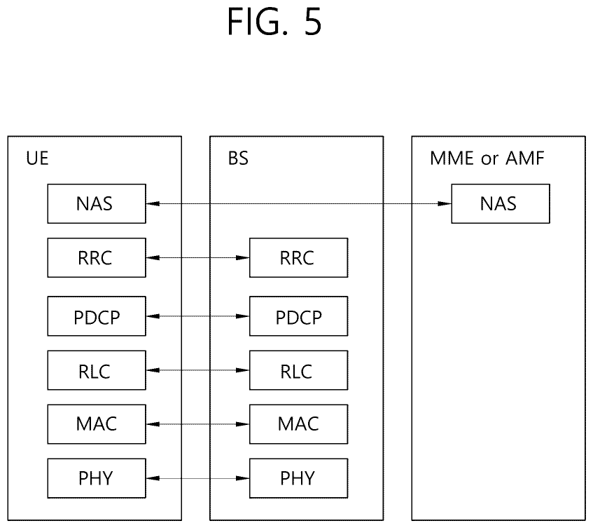

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

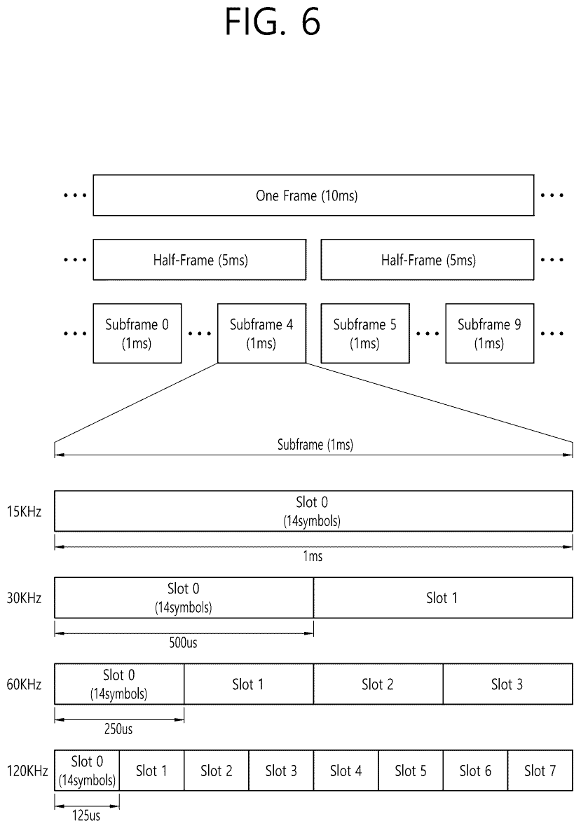

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} grid indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 kHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

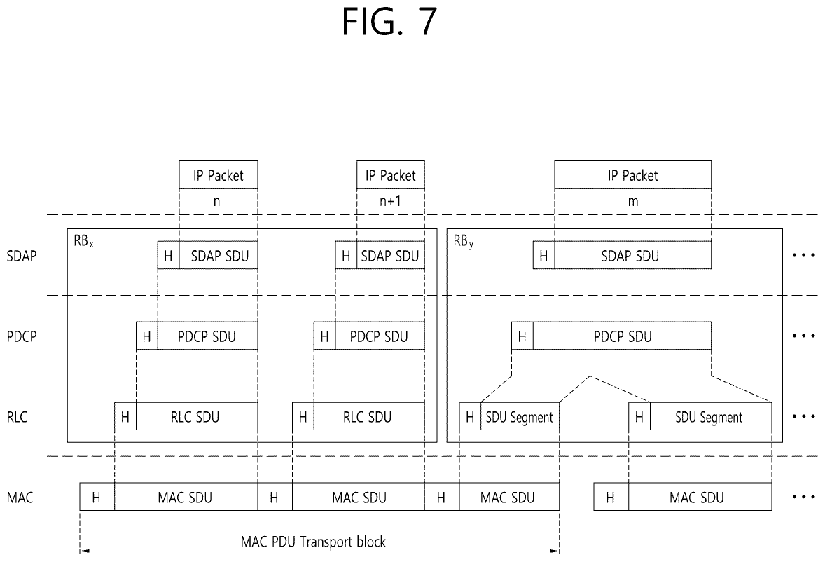

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding mobility are described.

The mobility may comprise PCell change, PSCell change (or, secondary node (SN) change), and/or PSCell addition (or, SN addition).

In the present disclosure, the term “handover (HO)” may mean PCell change, or may be a broad concept that includes not only PCell change but also PSCell change/addition.

In the present disclosure, the description regarding handover can also be applied to other mobility procedures (e.g., PSCell change/addition).

In the present disclosure, the terms “handover”, “mobility” and “cell switch” can be used interchangeably.

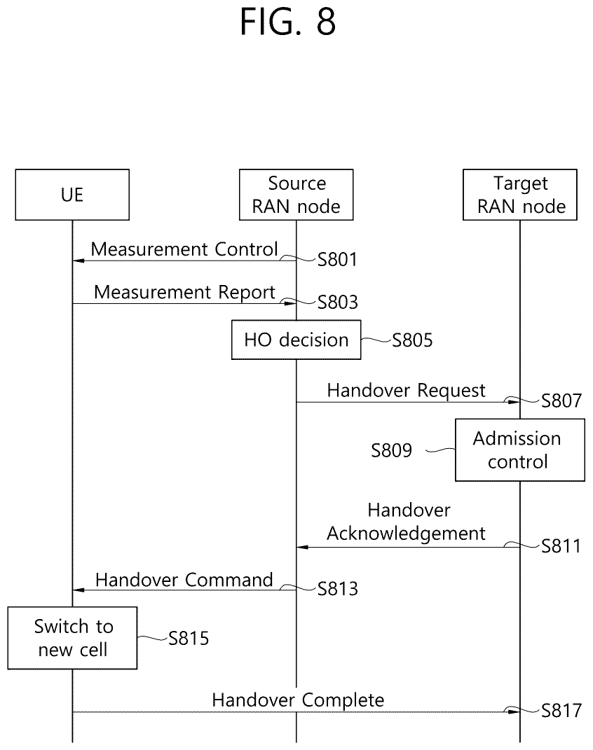

FIG. 8 shows an example of a legacy handover procedure to which technical features of the present disclosure can be applied.

Referring to FIG. 8, in step S801, the source RAN node may transmit measurement control message to the UE. The source RAN node may configure the UE measurement procedures according to the roaming and access restriction information and, for example, the available multiple frequency band information through the measurement control message. Measurement control information provided by the source RAN node through the measurement control message may assist the function controlling the UE's connection mobility. For example, the measurement control message may comprise measurement configuration and/or report configuration.

In step S803, the UE may transmit a measurement report message to the source RAN node. The measurement report message may comprise a result of measurement on neighbor cell(s) around the UE which can be detected by the UE. The UE may generate the measurement report message according to a measurement configuration and/or measurement control information in the measurement control message received in step S801.

In step S805, the source RAN node may make a handover (HO) decision based on the measurement report. For example, the source RAN node may make a HO decision and determine a target RAN node for HO among neighbor cells around the UE based on a result of measurement (e.g., cell quality, signal quality, signal strength, reference signal received power (RSRP), reference signal received quality (RSRP), channel state, channel quality, signal to interference plus noise ratio (SINR)) on the neighbor cells.

In step S807, the source RAN node may transmit a HO request message to the target RAN node which is determined in step S805. That is, the source RAN node may perform handover preparation with the target RAN node. The HO request message may comprise necessary information to prepare the handover at the target RAN node.

In step S809, the target RAN node may perform an admission control based on information included in the HO request message. The target RAN node may configure and reserve the required resources (e.g., C-RNTI and/or RACH preamble). The AS-configuration to be used in the target RAN node can either be specified independently (i.e. an “establishment”) or as a delta compared to the AS-configuration used in the source RAN node (i.e. a “reconfiguration”).

In step S811, the target RAN node may transmit a HO request acknowledge (ACK) message to the source RAN node. The HO request ACK message may comprise information on resources reserved and prepared for a handover. For example, the HO request ACK message may comprise a transparent container to be sent to the UE as an RRC message to perform the handover. The container may include a new C-RNTI, target gNB security algorithm identifiers for the selected security algorithms, a dedicated RACH preamble, and/or possibly some other parameters i.e. access parameters, SIBs. If RACH-less handover is configured, the container may include timing adjustment indication and optionally a preallocated uplink grant. The HO request ACK message may also include RNL/TNL information for forwarding tunnels, if necessary. As soon as the source RAN node receives the HO request ACK message, or as soon as the transmission of the handover command is initiated in the downlink, data forwarding may be initiated.

In step S813, the source RAN node may transmit a handover command, to the UE. For example, the handover command may comprise or may be a cell configuration (i.e., RRCReconfiguration message including the reconfigurationWithSync). The RRCReconfiguration message and/or reconfigurationWithSync for a target cell may comprise information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. The source RAN node may perform the necessary integrity protection and ciphering of the message.

In step S815, the UE may switch to anew cell i.e., the target RAN node. The UE may detach from the old cell i.e., the source RAN node and synchronize to anew cell i.e., the target RAN node. The UE may perform a handover from the source RAN node to the target RAN node based on applying the cell configuration. For example, upon receiving the handover command, the UE may start the T304 timer, and perform a contention-free random access towards the target RAN node based on the set of dedicated RACH resources.

In step S817, upon successful completion of the random access procedure, the UE may stop the T304 timer, and transmit a handover complete message (i.e., RRCReconfigurationComplete message) to the target RAN node. The UE may send the RRCReconfigurationComplete message comprising the C-RNTI to confirm the handover, to the target RAN node to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target RAN node. Upon expiry of the T304 timer, the UE may declare handover failure (HOF) and perform an RRC re-establishment procedure.

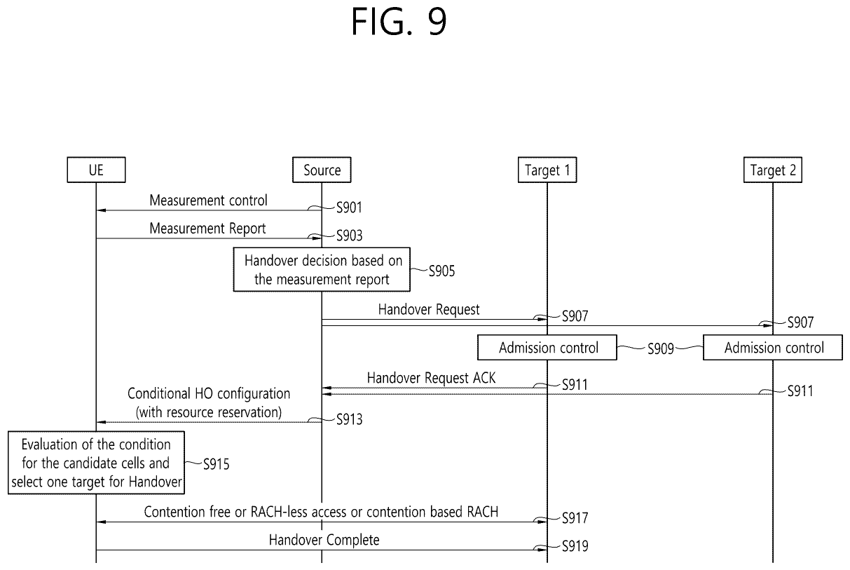

FIG. 9 shows an example of a conditional handover procedure to which technical features of the present disclosure can be applied.

Referring to FIG. 9, in step S901, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S903, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source cell may make a handover decision based on the measurement report. For example, the source cell may make a handover decision and determine candidate target cells (e.g., target cell 1 and target cell 2) for handover among neighbor cells around the UE based on a result of measurement (e.g., signal quality, reference signal received power (RSRP), reference signal received quality (RSRP)) on the neighbor cells.

In step S907, the source cell may transmit handover request messages to the target cell 1 and the target cell 2 which are determined in step S905. That is, the source cell may perform handover preparation with the target cell 1 and the target cell 2. The handover request message may comprise necessary information to prepare the handover at the target side (e.g., target cell 1 and target cell 2).

In step S909, each of the target cell 1 and the target cell 2 may perform an admission control based on information included in the handover request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S911, the target cell and the target cell 2 may transmit a handover request acknowledge (ACK) message to the source cell. The handover request ACK message may comprise cell configuration (i.e., RRCReconfiguration message including ReconfigurationWithSync) including information on resources reserved and prepared for a handover. For example, the handover request ACK message may comprise a transparent container to be sent to the UE as an RRC message (i.e., RRCReconfiguration message/cell configuration) to perform the handover. The container/cell configuration/RRCReconfiguration message may include information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. If RACH-less handover is configured, the container may include timing adjustment indication and optionally a pre-allocated uplink grant. The handover request ACK message may also include RNL/TNL information for forwarding tunnels, if necessary. As soon as the source cell receives the handover request ACK message, or as soon as the transmission of the conditional handover command is initiated in the downlink, data forwarding may be initiated.

In step S913, the source cell may transmit a RRCReconfiguration message including a conditional reconfiguration to the UE. The conditional reconfiguration may be also referred to as (or, may comprise) conditional handover (CHO) configuration and/or a conditional handover command (e.g., CHO command). The conditional reconfiguration may comprise a list of conditional reconfigurations/conditional handover commands, including a conditional reconfiguration/conditional handover command for each of the candidate target cells (e.g., target cell 1, target cell 2). For example, the conditional reconfiguration may comprise a conditional reconfiguration/conditional handover command for the target cell 1, and a conditional reconfiguration/conditional handover command for the target cell 2. The conditional reconfiguration for a target cell may comprise an index/identifier identifying the corresponding conditional reconfiguration, a handover condition for the target cell, and/or a cell configuration (i.e., RRCReconfiguration message including the reconfigurationWithSync) for the target cell. The RRCReconfiguration message and/or reconfigurationWithSync for the target cell may comprise information required to access the target cell comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell.

In step S915, the UE may perform an evaluation of the handover condition for the candidate target cells (e.g., target cell 1, target cell 2) and select a target cell for a handover among the candidate target cells. For example, the UE may perform measurements on the candidate target cells, and determine whether a candidate target cell fulfils a handover condition for the candidate target cell among the candidate target cells based on a result of the measurements on the candidate target cells. Or, the UE may determine whether the target cell/measurement result for the target cell fulfils the handover condition of the target cell. If the UE identifies that the target cell 1 fulfils a handover condition for the target cell 1, the UE may select the target cell 1 as a target cell for the handover.

In step S917, the UE may detach from the old cell i.e., the source cell and synchronize to a new cell i.e., the selected target cell. The UE may perform a handover from the source cell to the target cell based on applying the cell configuration. For example, upon receiving the handover command, the UE may start the T304 timer, and perform a contention-free random access towards the target cell based on the set of dedicated RACH resources.

In step S919, upon successful completion of the random access procedure, the UE may stop the T304 timer, and transmit a handover complete message (i.e., RRCReconfigurationComplete message) to the target cell. The UE may send the RRCReconfigurationComplete message comprising the C-RNTI to confirm the handover, to the target cell to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target cell. Upon expiry of the T304 timer, the UE may declare handover failure (HOF) and perform an RRC re-establishment procedure.

Hereinafter, L1/L2-triggered mobility (LTM) is described.

LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling.

An LTM candidate cell may be configured via a RRCReconfiguration message for candidate target cell, and/or a CellGroupConfig IE for each candidate target cell.

The following principles may apply to LTM:
Candidate cell configuration can be provided as delta configurations on top of a reference configuration. The reference configuration is managed separately, and UE stores the reference configuration as a separate configuration.
User plane is continued whenever possible (e.g., intra-distributed unit, DU), without reset, with the target to avoid data loss and the additional delay of data recovery.
Security is not updated in LTM.
Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios may be supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.
Dual connectivity scenario, at least for the PSCell change without MN involvement case, i.e. intra-SN.

Inter-cell beam management is also supported, but is not considered as a prerequisite for using LTM.

The design for intra-DU and inter-DU L1/L2-based mobility should share as much commonality as reasonable.

In some implementations, validity/compliance check of candidate cell configuration are performed upon reception of the candidate cells configuration.

Cell switch trigger information is conveyed in a MAC CE, which contains at least a candidate configuration index. Cell-specific, radio bearer, and measurement configurations can be part of an LTM candidate cell configuration.

In some implementations, the MAC CE can indicate TCI state(s) (or other beam information) to be activated for the target cell(s)

In some implementations, it is possible to perform SCell activation/deactivation (amongst SCells associated with the candidate configuration) simultaneously with the LTM triggering MAC CE.

UE may perform contention-based random access (CBRa) or contention-free random access (CFRa) at cell switch. UE may also skip random access procedure if UE doesn't need to acquire timing advance (TA) for the target cell during cell switch. RACH resources for CFRA are provided in RRC configuration.

In some implementations, the CFRA resources can be provide via MAC CE.

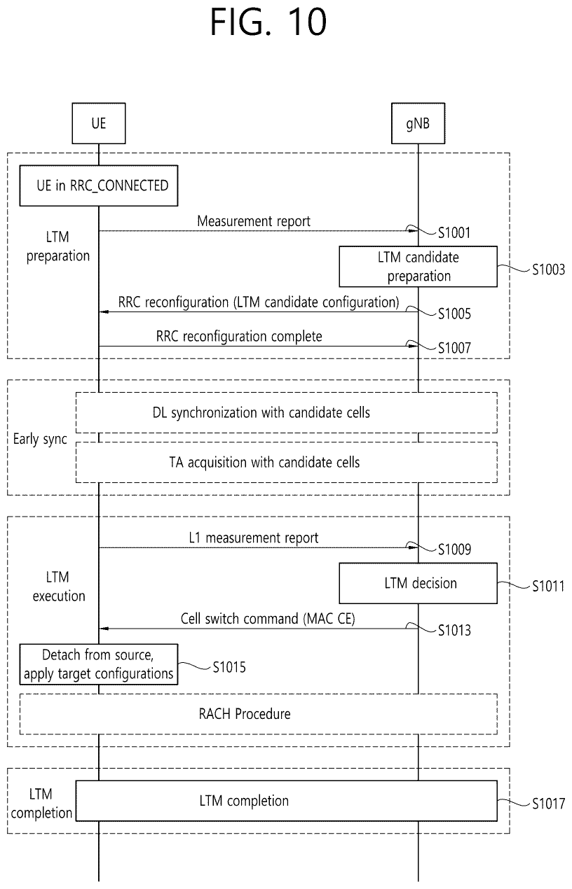

The overall procedure for LTM is shown in FIG. 10 below. Subsequent LTM is done by repeating the early synchronization, LTM execution, and LTM completion steps without releasing other candidates after each LTM completion.

FIG. 10 shows an example of a signaling procedure for LTM according to an embodiment of the present disclosure.

Referring to FIG. 10, in step S1001, UE may send aMeasurementReport message to gNB.

In step S1003, the gNB may decide to use LTM and initiate LTM candidate preparation.

In step S1005, the gNB may transmit an RRCReconfiguration message to the UE including the configuration of one or multiple LTM candidate target cells.

In step S1007, the UE may store the configuration of LTM candidate target cell(s) and transmit a RRCReconfigurationComplete message to the gNB.

In some implementations, the UE may optionally perform early synchronization. In this case, the UE may perform DL synchronization and/or TA acquisition with candidate target cell(s) before receiving the LTM cell switch command.

For example, DL synchronization for candidate cell(s) before cell switch command may be supported, at least based on SSB.

For example, TA acquisition of candidate cell(s) before LTM cell switch command may be supported, at least based on PDCCH ordered RACH, where the PDCCH order is only triggered by source cell.

In step S1009, UE may perform L1 measurements on the configured LTM candidate target cell(s), and transmit lower-layer measurement reports to the gNB. The lower-layer measurement reports may be carried on L1 or MAC.

In step S1011, the gNB may decide to execute LTM cell switch to atarget cell.

In step S1013, the gNB may transmit a MAC CE triggering LTM cell switch by including the candidate configuration index of the target cell. The UE may switch to the configuration of the LTM candidate target cell.

In step S1015, UE may detach from the source cell, and apply the target cell configuration(s). If TA is not available, the UE may perform a random access procedure towards the target cell.

In step S1017, the UE may indicate successful completion of the LTM cell switch towards the target cell.

In some implementations, an uplink signal or message after the UE has switched to the target cell may be used to indicate successful completion of the LTM cell switch.

Meanwhile, L1/L2 triggered mobility (LTM) is introduced in order to reduce latency, overhead and interruption time. For LTM, network may provide UE in advance with a configuration of a candidate cell (i.e., preconfiguration of candidate cells for LTM). Then, the UE may perform L1 measurement of the candidate cell and perform an L1 measurement reporting (i.e., report the measurement results for the candidate cell to the network). The network may determine that the UE executes LTM to the candidate cell based on the L1 measurement reporting. The network may transmit, to the UE, an LTM command (or, cell switch command) via L1/L2 signaling to trigger the UE to execute the LTM toward the candidate cell. Upon receiving the LTM command, the UE may execute the LTM, e.g., the UE may apply the preconfiguration of the candidate cell and then transmit a UL signal to the candidate cell.

In legacy conditional handover (CHO), the candidate cell may reserve resources indicated in the pre-configuration for the UE. Until the UE applies the configuration of the candidate cell or the network releases the pre-configuration of the candidate cell, the candidate cell does not allocate the resources indicated in the pre-configuration to another UE.

In LTM, UE needs to be configured with a number of candidate cells for dynamic cell switch. A candidate cell in LTM may reserve resources for the UE for a long time because the UE does not discard the configurations of candidate cells for subsequent LTM. Moreover, a cell may be configured as an LTM candidate cell for a plurality of UEs. Consequently, a candidate cell may undergo resource shortage by reserving many resources for LTM between the pre-configuration and LTM execution.

In the present disclosure, ‘cell switch’ and ‘LTM execution’ can be used interchangeably.

In the present disclosure, ‘cell switch command’ and ‘LTM command’ can be used interchangeably.

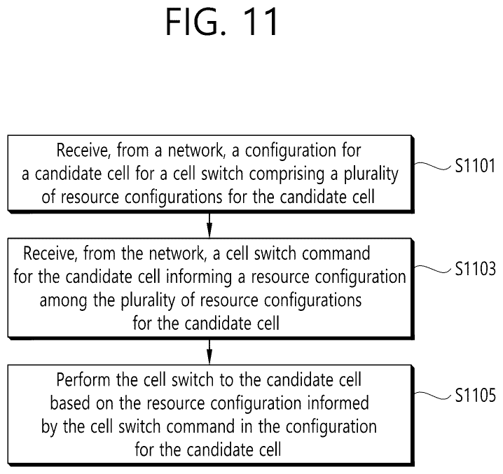

FIG. 11 shows an example of a method performed by a UE according to an embodiment of the present disclosure. The method may also be performed by a wireless device.

Referring to FIG. 11, in step S1101, UE may receive, from a network, a configuration for a candidate cell for a cell switch. The configuration for the candidate cell may comprise a plurality of resource configurations for the candidate cell.

In step S1103, UE may receive, from the network, a cell switch command for the candidate cell. The cell switch command may inform a resource configuration among the plurality of resource configurations for the candidate cell.

In step S1105, UE may perform the cell switch to the candidate cell based on the resource configuration informed by the cell switch command in the configuration for the candidate cell.

According to various embodiments, UE may receive, from the network, a plurality of configurations for candidate cells for the cell switch including the configuration for the candidate cell. Each of the plurality of configurations may be related to a corresponding candidate cell, and comprise: a candidate configuration index of a configuration for the corresponding candidate cell; and a plurality of resource configurations related to the candidate configuration index. Each of the plurality of resource configurations may comprise a resource configuration index of a corresponding resource configuration.

According to various embodiments, the cell switch command may comprise: a candidate configuration index of the configuration for the candidate cell; and a resource configuration index of the resource configuration among the plurality of resource configurations related to the candidate configuration index.

According to various embodiments, the UE may perform L1 measurements on the candidate cells to obtain L1 measurement results for the candidate cells. The UE may transmit, to the network, a L1 measurement report comprising the L1 measurement results. The UE may receive the cell switch command after transmitting the L1 measurement report to the network.

According to various embodiments, the UE may identify, among the plurality of configurations for the candidate cells, the configuration for the candidate cell with matching candidate configuration index in the cell switch command. The UE may identify, among the plurality of resource configurations in the configuration for the candidate cell, the resource configuration with matching resource configuration index in the cell switch command.

According to various embodiments, the plurality of configurations for the candidate cells may be received via an RRC signaling. The cell switch command may be received via a MAC CE signaling.

According to various embodiments, the cell switch may comprise an LTM. The cell switch command may comprise an LTM command.

According to various embodiments, the plurality of resource configurations comprise at least one of: a set of physical channel configurations; a set of DL BWP configurations; a set of UL BWP configurations; a set of SCell states; a set of TA values; a set of TCI states; a set of indications for at least one of PDCP recovery, RLC re-establishment, or MAC reset; a set of SSB indexes; a set of CSI-RS indexes; or indications of whether the UE performs a random access or not upon performing the cell switch.

According to various embodiments, the set of physical channel configurations may comprise at least one of a set of PUCCH configurations; a set of PUSCH configurations; a set of PDCCH configurations; a set of PDSCH configurations; or a set of PRACH configurations.

According to various embodiments, to perform the cell switch, the UE may: apply the configuration for the candidate cell; and transmitting, to the candidate cell, one or more UL signals. The one or more UL signals may comprise a UL signal transmitted based on the resource configuration informed by the cell switch command.

According to various embodiments, the cell switch may comprise a RACH-based cell switch. The one or more UL signals may comprise at least one of: a random access preamble transmitted based on a PRACH configuration informed by the cell switch command; or an RRC reconfiguration complete message transmitted based on a UL grant provided by a random access response for the random access preamble.

According to various embodiments, the cell switch may comprise a RACH-less cell switch. The one or more UL signals may comprise at least one of: a scheduling request transmitted based on a PUCCH configuration informed by the cell switch command; an LTM complete MAC CE transmitted based on a first PUSCH configuration informed by the cell switch command; or an RRC reconfiguration complete message transmitted based on a second PUSCH configuration informed by the cell switch command.

According to various embodiments, the UE may receive, from the network, an RRC configuration for a candidate cell. The RRC configuration may include two or more sets of configurations for a physical channel of a BWP. The UE may receive, from the network, a cell switch command to the candidate cell. The cell switch command may indicate one set of the two or more sets of the configurations for the physical channel. The UE may access to the candidate cell based on the indicated set of the configuration for the physical channel.

According to various embodiments, the candidate cell may become anew serving cell upon execution of the cell switch command.

According to various embodiments, the access to the candidate cell may be based on at least one of: transmitting, to the candidate cell, a UL signal through the UL resource corresponding to the indicated set of the configuration for the physical channel; or receiving, from the candidate cell, a DL signal through the DL resource corresponding to the indicated set of the configuration for the physical channel.

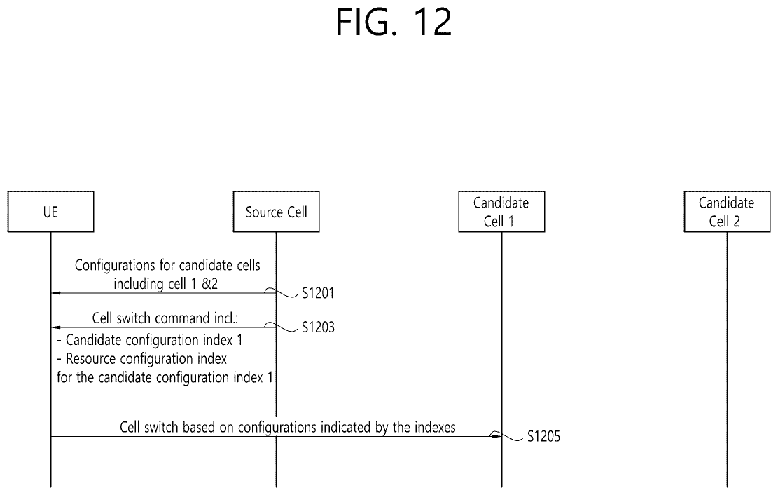

FIG. 12 shows an example of a signal flow between a UE and a network node according to an embodiment of the present disclosure. The network node may comprise a base station (BS), and may be related to a source cell in cell switch.

Referring to FIG. 12, in step S1201, the network node may transmit, to a UE, a plurality of configurations for candidate cells for cell switch. The plurality of configurations for the candidate cells may include a configuration for a candidate cell 1 and a configuration for a candidate cell 2. Each of the plurality of configurations may be related to a corresponding candidate cell, and comprise: a candidate configuration index of a configuration for the corresponding candidate cell; and a plurality of resource configurations related to the candidate configuration index. Each of the plurality of resource configurations may comprise a resource configuration index of a corresponding resource configuration.

In step S1203, the network node may transmit, to the UE, a cell switch command comprising: i) a candidate configuration index of a configuration for the candidate cell 1 (i.e., candidate configuration index 1); and ii) a resource configuration index of a resource configuration among a plurality of resource configurations in the configuration for the candidate cell 1 (i.e., resource configuration index for the candidate configuration index 1). The UE may identify, among the plurality of configurations for the candidate cells, the configuration for the candidate cell 1 informed by the candidate configuration index 1. The UE may identify, among the plurality of resource configurations in the configuration for the candidate cell 1, the resource configuration informed by the resource configuration index 1.

In step S1205, the UE may perform the cell switch to the candidate cell 1 based on the configuration for the candidate cell 1 informed by the candidate configuration index 1, and/or the resource configuration informed by the resource configuration index.

According to implementations of the present disclosure, a network (NW) may preconfigure a UE with two or more sets of configurations for a physical channel for a bandwidth part (BWP) of a candidate cell. When the NW decides the UE to perform LTM execution to the candidate cell, the candidate cell may reserve a physical channel configuration out of the preconfigured set of corresponding physical channel configurations in the first BWP for the UE. Then, the NW may transmit an LTM command, to the UE, indicating the physical channel configuration that the candidate cell is reserving for LTM execution. Upon receiving the LTM command from the NW, the UE may execute the LTM to the candidate cell, i.e., the UE may apply the preconfiguration with the indications by the LTM command and then the UE may transmit a UL signal using the indicated physical channel configuration to the target cell/candidate cell.

The NW may preconfigure the UE with two or more sets of configurations for a physical channel for a bandwidth part (BWP) of a candidate cell. This means that a BWP configuration of the preconfiguration may include multiple sets of a physical channel configuration, e.g., set of PUCCH configurations, set of PUSCH configurations, set of PDCCH configurations, set of PDSCH configurations, and/or set of PRACH configurations. The preconfiguration of the candidate cell may comprise of two parts: i) a part that the UE applies directly at the time of LTM execution; and ii) another part that the UE selectively applies based on the indications included in the LTM command upon LTM execution. Then, the candidate cell does not reserve the resources corresponding to the set of a physical channel configuration configured in the BWP configuration of the preconfiguration. This implies that the candidate cell may allocate a set of a physical channel configurations included in the preconfiguration to another UE until the UE starts to apply the preconfiguration (i.e., LTM execution at the UE).

When the NW decides the UE to perform cell switch to the candidate cell, the candidate cell may reserve a physical channel configuration out of the preconfigured set of corresponding physical channel configurations (which can be referred to as “corresponding set”) in the first BWP for the UE. The first BWP, which should be applied at the UE upon LTM execution, may be indicated by the LTM command or the preconfiguration. The negotiation between the source cell and the target cell/candidate cell may be necessary to decide which physical channel configuration out of the corresponding set will be indicated to the UE by the LTM command. After the negotiation, the target cell/candidate cell may reserve the physical channel configuration(s) determined to use for the LTM execution.

Then, the NW transmit, to the UE, an LTM command indicating the physical channel configuration that the candidate cell is reserving for LTM execution. The LTM command may indicate the configuration index of the physical channel configuration, which should be applied at the UE upon LTM execution.

Upon receiving the LTM command from the NW, the UE may execute the LTM to the candidate cell, i.e., the UE may apply the preconfiguration with the indications by the LTM command. Then, the UE may transmit the first UL signal to the candidate cell. The first signal may be: i) the RA preamble in the case of RACH-based LTM execution; or ii) scheduling request or the MAC CE indicating the UE arrival in the case of RACH-less LTM execution. The first UL signal may be transmitted on the UL resource corresponding to the indicated physical channel configuration.

For signaling of the indication, the indication may be included in LTM command. The indication may be configured as part of the candidate cell configuration. The indication may be pre-configured as part of a BWP configuration. That is, the indication may be pre-configured per-BWP. When multiple BWPs are configured, the indication may be provided in each of the BWP configurations.

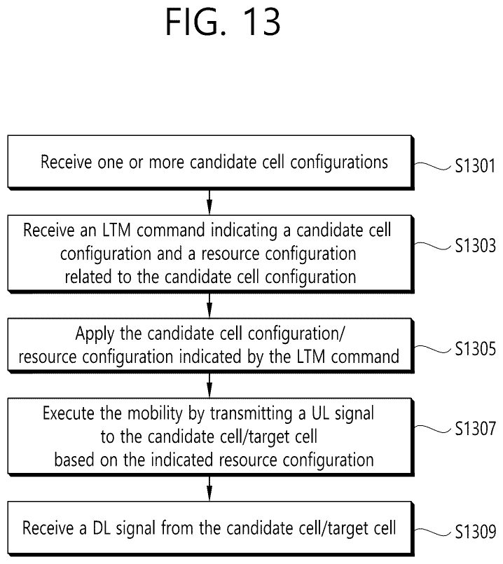

FIG. 13 shows an example of a method for indicating a physical channel configuration in LTM according to an embodiment of the present disclosure. The method may be performed by a UE and/or a wireless device.

Referring to FIG. 13, in step S1301, UE may receive one or more candidate cell configurations (i.e., a plurality of configurations for candidate cells). That is, one or more candidate serving cells may be configured. The (pre)configuration of a candidate cell may comprise at least one of a part that the UE applies directly at the time of LTM execution; or another part that the UE selectively applies based on the indications included in the LTM command upon LTM execution.

A candidate cell configuration may comprise at least one of
configuration(s) for a special cell, e.g., servingCellConfigCommon, servingCellConfig, reconfigurationWithSync, RLF relevant configuration;
configuration(s) for SCells, e.g., servingCellConfigCommon, servingCellConfig, smtc, DRX configuration;
MAC/RLC related configurations; or
set of BWP configurations.

For each BWP configuration, a flag may be included to indicate whether the UE firstly applies the corresponding BWP configuration upon LTM execution or not. Sets of resource configurations such as configurations for a physical channel (i.e., sets of physical channel configurations) can be included in each BWP configuration. For example, each BWP configuration may comprise at least one of a set of PUCCH configurations, a set of PUSCH configurations, a set of PDCCH configurations, a set of PDSCH configurations, or a set of PRACH configurations. For each physical channel configuration in a set, a flag may be included to indicate whether the UE firstly applies the corresponding physical channel configuration upon LTM execution or not.

In step S1303, UE may receive an LTM command (i.e., cell switch command) indicating a candidate cell configuration (i.e., configuration of a candidate cell) and a resource configuration related to the candidate cell configuration. The LTM command can be transmitted via L1/L2/L3 signalling. The LTM command may be related to either network controlled serving cell change or UE autonomous serving cell change (e.g., conditional mobility).

The LTM command may comprise at least one of
target cell information: if a target cell is one of the preconfigured candidate serving cells for the UE, the target cell information may be an identifier of the candidate serving cell/candidate cell configuration indicated by the LTM command. Else (i.e., target cell is not one of the preconfigured candidate serving cells for the UE), the target cell information may be a configuration for the target cell/candidate cell configuration (e.g., RRCReconfiguration including reconfigurationWithSync).
ConditionalReconfiguration, in case of conditional mobility.
indicator indicating that the source cell is changed to a candidate serving cell: For example, the indicator may be a 1-bit indication in DCI or MAC CE. For example, the LTM command via L1/L2 signalling may implicitly indicate that the source cell is changed to a candidate serving cell. For example, the target cell may be included in a list, where the list may indicate that the source cell is changed to a candidate serving cell. For example, the indicator may be an explicit RRC information element (IE).
Configuration for the UE to apply upon LTM execution (i.e., resource configuration): For example, the configuration may comprise a physical channel configuration index indicating a PRACH configuration out of the set of PRACH configurations, a PUCCH configuration out of the set of PUCCH configurations, a PUSCH configuration out of the set of PUSCH configurations, a PDCCH configuration out of the set of PDCCH configurations, and/or a PDSCH configuration out of the set of PDSCH configurations. The configuration may comprise DL/UL BWP index, SCell state, TA information, TCI state, indications for L2 operations (e.g., PDCP recovery/RLC re-establishment/MAC (full or partial) reset), SSB/CSI-RS, and/or indication whether the UE performs random access or not upon LTM execution.

In step S1305, the UE may apply the candidate cell configuration/resource configuration indicated by the LTM command.

For example, if the received LTM command has ConditionalReconfiguration (i.e., in case of conditional mobility), the UE may apply the stored configuration (e.g., condRRCReconfig) of the cell for which an execution condition is satisfied

For example, if the received LTM command does not have ConditionalReconfiguration (i.e., in case of legacy mobility), the UE may apply the configuration of stored candidate cell/candidate cell configuration, which is indicated in the LTM command. If the LTM command includes the configuration for the UE to apply upon LTM execution (i.e., resource configuration), the UE may selectively apply the preconfiguration with the indications by the LTM command. For example, if the preconfiguration has first and second PRACH configurations for the BWP and if the LTM command indicates the first PRACH configuration, then for the PRACH configuration the UE applies the first PRACH configuration, not the second PRACH configuration. Else if the LTM command does not include the configuration for the UE to apply upon LTM execution, the UE may directly apply the preconfiguration of the candidate cell.

In step S1307, the UE may execute the mobility by transmitting a UL signal to the candidate cell (i.e., the target cell) based on the indicated resource configuration.

In some implementations, the UE may transmit the UL signal to the candidate cell via L1 signalling (e.g., PUCCH, PUSCH, PRACH). For example, the UE may transmit, to the candidate cell, a random access (Ra) preamble in case of RACH-based LTM execution. For example, the UE may transmit, to the candidate cell, scheduling request in case of RACH-less LTM execution.

In some implementations, the UE may transmit the UL signal to the candidate cell via L2 signalling (e.g., MAC CE). For example, the UE may transmit, to the candidate cell, an LTM Complete MAC CE indicating the UE arrival in case of RACH-less LTM execution.

In some implementations, the UE may transmit the UL signal to the candidate cell via L3 signalling (e.g., RRCReconfigurationComplete).

The first UL signal may be transmitted on the UL resource corresponding to the indicated resource configuration (e.g., physical channel configuration). For example, if the LTM command indicates a specific PRACH configuration, then the UE may transmit the RA preamble corresponding to the indicated PRACH configuration. For example, if the LTM command does not include the information of physical channel configuration and if the BWP configuration that the UE applies upon LTM execution has one physical channel configuration, then the UE may transmit the first UL signal on the UL resource corresponding to the physical channel configuration in the BWP configuration.

In some implementations:
If the mobility message (i.e., LTM command/cell switch command) is transmitted via L1/L2 signalling, the UE may keep the source resources and configurations, and/or perform TA maintenance and beam failure detection (BFD)/radio link monitoring (RLM) on the source cell/target cell.
If the mobility message includes the indicator indicating that the source cell is changed to a candidate serving cell, the UE may keep the source resources and configurations, and/or perform TA maintenance and BFD/RLM on the source cell/target cell
Else, the UE may release the source resources and configurations and/or stop DL/UL reception/transmission with the source cell.

In step S1309, the UE may receive a DL signal from the candidate cell (i.e., the target cell). The first DL signal may be conveyed via PDCCH and/or PDSCH.

Furthermore, the method in perspective of the UE described in the present disclosure (e.g., in FIG. 11) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

Furthermore, the method in perspective of the UE described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

Furthermore, the method in perspective of the UE described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network, a configuration for a candidate cell for a cell switch, wherein the configuration for the candidate cell comprises a plurality of resource configurations for the candidate cell; receiving, from the network, a cell switch command for the candidate cell, wherein the cell switch command informs a resource configuration among the plurality of resource configurations for the candidate cell; and performing the cell switch to the candidate cell based on the resource configuration informed by the cell switch command in the configuration for the candidate cell.

Furthermore, the method in perspective of a network node related to a source cell in cell switch described in the present disclosure (e.g., in FIG. 12) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a configuration for a candidate cell for a cell switch, wherein the configuration for the candidate cell comprises a plurality of resource configurations for the candidate cell; and transmitting, to the UE, a cell switch command for the candidate cell, wherein the cell switch command informs a resource configuration among the plurality of resource configurations for the candidate cell, wherein the cell switch is performed to the candidate cell based on the resource configuration informed by the cell switch command in the configuration for the candidate cell.

The present disclosure may have various advantageous effects.

For example, according to the present disclosure, network (NW) may preconfigure UE with one or more physical channel configurations for a bandwidth part (BWP) of a candidate cell. When the NW decides the UE to perform LTM execution to the candidate cell, the candidate cell may reserve one out of preconfigured physical channel configurations in the first BWP for the UE. Then, the NW may transmit an LTM command to the UE, indicating the physical channel configuration that the candidate cell is reserving for LTM execution. Upon receiving the LTM command from the NW, the UE may execute the LTM to the candidate cell—that is, the UE may apply the preconfiguration with the indications by the LTM command.

To this end, the network may prevent the resource shortage problem by dynamically allocating the physical resource for use by the UE at the moment of LTM execution. As a result, the efficiency of network resource utilization can be improved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network, a configuration for a candidate cell for a cell switch, wherein the configuration for the candidate cell comprises a plurality of resource configurations for the candidate cell;
receiving, from the network, a cell switch command for the candidate cell, wherein the cell switch command informs a resource configuration among the plurality of resource configurations for the candidate cell; and
performing the cell switch to the candidate cell based on the resource configuration informed by the cell switch command in the configuration for the candidate cell.

2. The method of claim 1, wherein the receiving of the configuration for the candidate cell comprises receiving, from the network, a plurality of configurations for candidate cells for the cell switch including the configuration for the candidate cell,
wherein each of the plurality of configurations is related to a corresponding candidate cell, and comprises:
a candidate configuration index of a configuration for the corresponding candidate cell; and
a plurality of resource configurations related to the candidate configuration index, and
wherein each of the plurality of resource configurations comprises a resource configuration index of a corresponding resource configuration.

3. The method of claim 1, wherein the cell switch command comprises:
a candidate configuration index of the configuration for the candidate cell; and
a resource configuration index of the resource configuration among the plurality of resource configurations related to the candidate configuration index.

4. The method of claim 1, further comprising:
performing layer 1 (L1) measurements on the candidate cells to obtain L1 measurement results for the candidate cells; and
transmitting, to the network, a L1 measurement report comprising the L1 measurement results,
wherein the receiving of the cell switch command comprises receiving the cell switch command after transmitting the L1 measurement report to the network.

5. The method of claim 2, further comprising:
identifying, among the plurality of configurations for the candidate cells, the configuration for the candidate cell with matching candidate configuration index in the cell switch command; and
identifying, among the plurality of resource configurations in the configuration for the candidate cell, the resource configuration with matching resource configuration index in the cell switch command.

6. The method of claim 2, wherein the plurality of configurations for the candidate cells are received via a radio resource control (RRC) signaling, and
wherein the cell switch command is received via a media access control (MAC) control element (CE) signaling.

7. The method of claim 1, wherein the cell switch comprises a layer 1 (L1)/layer 2 (L2)-triggered mobility (LTM), and
wherein the cell switch command comprises an LTM command.

8. The method of claim 1, wherein the plurality of resource configurations comprise at least one of:
a set of physical channel configurations;
a set of downlink (DL) bandwidth part (BWP) configurations;
a set of UL BWP configurations;
a set of secondary cell (SCell) states;
a set of timing advance (TA) values;
a set of transmission configuration indicator (TCI) states;
a set of indications for at least one of packet data convergence protocol (PDCP) recovery, radio link control (RLC) re-establishment, or media access control (MAC) reset;
a set of synchronization signal block (SSB indexes;
a set of channel state information (CSI)-reference signal (RS) indexes; or
indications of whether to perform a random access or not upon performing the cell switch.

9. The method of claim 8, wherein the set of physical channel configurations comprise at least one of a set of physical uplink control channel (PUCCH) configurations;
a set of physical uplink shared channel (PUSCH) configurations;
a set of physical downlink control channel (PDCCH) configurations;
a set of physical downlink shared channel (PDSCH) configurations; or
a set of physical random access channel (PRACH) configurations.

10. The method of claim 1, wherein the performing of the cell switch comprises:
applying the configuration for the candidate cell; and
transmitting, to the candidate cell, one or more uplink (UL) signals,
wherein the one or more UL signals comprise a UL signal transmitted based on the resource configuration informed by the cell switch command.

11. The method of claim 10, wherein the cell switch comprises a random access channel (RACH)-based cell switch, and
wherein the one or more UL signals comprise at least one of:
a random access preamble transmitted based on a physical random access channel (PRACH) configuration informed by the cell switch command; or
a radio resource control (RRC) reconfiguration complete message transmitted based on a UL grant provided by a random access response for the random access preamble.

12. The method of claim 10, wherein the cell switch comprises a random access channel (RACH)-less (RACH-less) cell switch, and
wherein the one or more UL signals comprise at least one of:
a scheduling request transmitted based on a physical uplink control channel (PUCCH) configuration informed by the cell switch command;
a layer 1 (L1)/layer 2 (L2)-triggered mobility (LTM) complete media access control (MAC) control element (CE) transmitted based on a first physical uplink shared channel (PUSCH) configuration informed by the cell switch command; or
a radio resource control (RRC) reconfiguration complete message transmitted based on a second PUSCH configuration informed by the cell switch command.

13. The method of claim 1, wherein the method is performed by a user equipment (UE) in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
receiving, from a network, a configuration for a candidate cell for a cell switch, wherein the configuration for the candidate cell comprises a plurality of resource configurations for the candidate cell;
receiving, from the network, a cell switch command for the candidate cell, wherein the cell switch command informs a resource configuration among the plurality of resource configurations for the candidate cell; and
performing the cell switch to the candidate cell based on the resource configuration informed by the cell switch command in the configuration for the candidate cell.

15. (canceled)

16. A network node comprising:
at least one transceiver;
at least one processor; and
at least one memory operatively coupled to the at least one processor and storing instructions that, based on being executed by the at least one processor, perform operations comprising:
transmitting, to a user equipment (UE), a configuration for a candidate cell for a cell switch, wherein the configuration for the candidate cell comprises a plurality of resource configurations for the candidate cell; and
transmitting, to the UE, a cell switch command for the candidate cell, wherein the cell switch command informs a resource configuration among the plurality of resource configurations for the candidate cell,
wherein the cell switch is performed to the candidate cell based on the resource configuration informed by the cell switch command in the configuration for the candidate cell.

17. (canceled)

18. (canceled)

19. (canceled)

20. (canceled)
